(19) United States
(12) Patent Application Publication
(10) Pub. No.: US 2021/0244582 A1
(43) Pub. Date: Aug. 12, 2021

(54) Built-In Stretcher Battery System

(71) Applicant: Lucas Decker, Alcoa, TN (US)

(72) Inventor: Lucas Decker, Alcoa, TN (US)

(21) Appl. No.: 16/849,097

(22) Filed: Apr. 15, 2020

Related U.S. Application Data
(60) Provisional application No. 62/972,607, filed on Feb. 10, 2020.

(51) Int. Cl. A61G 1/04; H01M 2/10; A61G 1/02

(52) U.S. Cl. CPC A61G 1/04; H01M 2220/20; A61G 1/02; H01M 2/1083

(57) ABSTRACT

The present invention relates generally to a portable and self-sufficient patient transport system. More specifically, the present invention relates to a portable stretcher featuring an onboard power supply comprised of an integrated inverter, a battery pack, a power strip, a charging port and other accessories to improve patient care, especially in critical care situations. The built-in stretcher battery system of the present invention ensures that all necessary medical devices associated with the stretcher, and the stretcher itself, are electrically powered and able to be used in transit without the need to be tethered to an external power source.

### CROSS-REFERENCE TO RELATED APPLICATION

The present application claims priority to, and the benefit of, U.S. Provisional Application No. 62/972,706, which was filed on Feb. 11, 2020 and is incorporated herein by reference in its entirety.

### BACKGROUND

The present invention relates generally to a portable and self-sufficient patient transport system. More specifically, the present invention relates to a portable stretcher featuring an onboard power supply preferably comprised of an integrated inverter, a battery pack, a power strip, a charging port and other accessories to improve patient care, especially in critical care situations. The built-in stretcher battery system of the present invention ensures that all necessary medical devices associated with the stretcher, and the stretcher itself, are electrically powered and able to be used in transit without the need to be tethered to an external power source. Accordingly, the present specification makes specific reference thereto. However, it is to be appreciated that aspects of the present invention are also equally amenable to other similar applications.

Patient transport units, such as medical stretchers and the like, are well known in the art for the mobile transportation of patients, and particularly of seriously injured and/or unconscious patients. Such mobile stretchers generally include a collapsible frame, wheels, swivels, rotatable casters, adjustable height and tilt mechanisms, foot pedals for controlling movement of the patient support surface, push handles for propelling and steering the stretcher, lifts to elevate and lower the patient support surface, and associated medical devices that may require an external electrical power source to function. Unfortunately, during transport, the paramedics, Emergency Medical Services (EMS) professionals, first responders and other users may not have access to such external power sources. Without a portable power source for the stretcher, the associated medical devices may not be able to be used until an external power source is available. This inability to use otherwise potentially life-saving medical devices during the patient transport process can, unfortunately, worsen patient outcomes and can be detrimental to overall patient care. Further, even those medical devices that can, for example, be plugged into a wall inverter in an ambulance or other external power source tend to slow down EMS personnel and other first responders that are in the midst of an emergency because they have to be plugged/unplugged into the ambulance or external other power source, create a tripping hazard because of the use of elongated electrical power cords, and offer limited range. More specifically, the distance between the stretcher and the ambulance or other electrical power source may exceed the length of the available electrical cord or extension cord.

Accordingly, there is a long felt need in the art for a portable patient transport device, such as a stretcher, that is comprised of a built-in or onboard electrical power supply system. There is also a long felt need in the art for a portable patient stretcher comprised of an onboard electrical power supply system that can be used to not only power the stretcher itself (e.g., a stretcher drive assembly), but that can also simultaneously power a plurality of associated medical devices that can be used to provide potentially life-saving care to the patient during the transportation process. Additionally, there is also a long felt need in the art for an onboard electrical power supply system for a portable patient stretcher that does not require an external power source or tethering to the same via, for example, an extension cord. Further, there is a long felt need in the art for an onboard electrical power supply system for a portable patient stretcher that is rechargeable, detachable from the stretcher itself and capable of being transported by hand to a remote location. Finally, there is a long felt need in the art for a portable patient stretcher having an onboard electrical power supply system that is both safe and easy to use and transport.

The subject matter disclosed and claimed herein, in one embodiment thereof, comprises an improved patient transport unit in the form of a stretcher that is comprised of an onboard electrical power supply system. More specifically, the onboard electrical power supply system is removably attachable to the stretcher and is preferably comprised of an inverter, a rechargeable battery pack, a power strip, and a charging port. The charging port allows the rechargeable battery pack to be charged by an external power source such as a wall outlet or our electrical source. Power from the rechargeable battery pack is then routed through the inverter and to the power strip wherein it may be used to, for example, power a drive assembly system on the portable stretcher and/or a plurality of associated medical devices that can be used to provide potentially life-saving care to the patient during the transportation process. Importantly, the onboard electrical power supply system of the present invention is detachable from the stretcher itself and can be transported by an EMS or other first responder, along with other appropriate and portable medical devices, to a remote location where an injured person may be located and used to provide immediate medical care until such time that the individual can be transported to an appropriate medical facility.

In this manner, the improved patient transport system of the present invention accomplishes all of the forgoing objectives, thereby improving patient care, especially in critical care situations, by ensuring that all necessary medical devices are powered and able to be used in transit. Use of the improved patient transport system offers safety and ease to the patient and medical support staff.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises an improved patient transport system equipped with a means for providing portable electrical power without being electrically tethered to an external power source or grid. The improved patient transport system is preferably comprised of a portable stretcher device, an onboard electrical power supply system removably attached thereto, and one or more medical devices removably attached to the portable stretcher device and/or in electrical communication with the onboard electrical power supply system.

The portable stretcher device is similar to those portable stretcher devices known in the art and is typically comprised of a frame, a head support, a patient receiving surface attached to the frame, a foot portion, one or more handles and a plurality of wheels also attached to said frame for easily transporting the portable stretcher device across a hard surface. In a preferred embodiment of the present invention, the portable stretcher device is further comprised of an electrical motor and a drive assembly in electrical communication with the onboard electrical power supply system for powering the wheels of the portable stretcher, thereby making the improved patient transport system and the patient positioned thereon easier to transport for the EMS or other first responder. It is also contemplated that the portable stretcher device could include other commonly known features such as adjustable height and tilt mechanisms, foot pedals for controlling movement of the patient support surface, push handles for easier mobility and steering, lifts to elevate and lower the patient support surface, shrouds for enclosing portions or the frame and/or to accommodate instruments, and a braking system for preventing undesired rotation of said wheels and the portable stretcher device.

As previously stated, the onboard electrical power supply system may be removably attached to the portable stretcher device so that it can be removed and transported by hand into a remote location to provide care to an injured patient where it may not be otherwise practical to immediately take the portable stretcher device. Nonetheless, it is also contemplated that the onboard electrical power supply system may be permanently affixed to, or integrated in, the portable stretcher device to, for example, prevent theft or loss of the same. The onboard electrical power supply system is preferably comprised of an inverter, a battery pack, a power strip, and a charging port, all in electrical communication with one another, either directly or indirectly, and capable of providing stand-alone electrical power to the portable stretcher device and/or a plurality of medical devices. The battery pack is preferably rechargeable and can be recharged via the charging port, which in turn can be in electrical communication with a traditional power source such as a wall outlet or a generator via, for example, an electrical cord. Once charged, the battery pack provides electrical power to the power strip via the inverter. The power strip further comprises a plurality of electrical outlets to which the portable stretcher device motor and/or plurality of medical devices may be plugged into to receive electrical power. It is also contemplated that the power strip could comprise one or more charging ports for other electronic devices, such as smart phones and the like.

The plurality of medical devices may be any medical device known in the art that requires electrical power to function, and that is useful in providing immediate care to a patient in a remote setting. In this manner, the onboard electrical power supply system may be used to power said medical devices without the need for a wall outlet or other traditional grid based power source and affords EMS professionals and other first responders with a portable and continuous power source for their electronic devices. Finally, the improved patient transport system of the present invention improves patient care, especially in critical care situations, by ensuring that all necessary medical devices are powered and able to be used in transit.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the improved patient transport system of the present invention and in accordance with the disclosed architecture.

FIG. 2 illustrates a perspective view of one potential embodiment of the onboard electrical power supply system of the improved patient transport system of the present invention and in accordance with the disclosed architecture.

FIG. 3 illustrates a partial perspective view of one potential embodiment of the onboard electrical power supply system of the improved patient transport system of the present invention removably attached to the portable stretcher device in accordance with the disclosed architecture.

FIG. 4 illustrates a partial perspective view of one potential embodiment of the onboard electrical power supply system of the improved patient transport system of the present invention fixedly attached to the portable stretcher device in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As noted above, existing patient transport devices are well known in the art for transporting patients, particularly those that have been seriously injured and/or are unconscious. Such transport devices are typically comprised of a collapsible frame, wheels, swivels, rotatable casters, adjustable height and tilt mechanisms, foot pedals for controlling movement of the patient support surface, push handles for mobility, lifts to elevate and lower the patient support surface, and associated medical devices that may require an external electrical power source to function, but do not include an onboard electrical power supply system for powering the transport device or the medical devices associated therewith without an external power source. Without an onboard electrical power supply system, the EMS professionals and other first responders are not able to take full advantage of the medical devices in their possession, and this inability to use otherwise potentially life-saving medical devices during the patient transport process can, unfortunately, worsen patient outcomes and can be detrimental to overall patient care.

Accordingly, and as also noted above, there is a long felt need in the art for a patient transport device that is comprised of both a portable stretcher device and an onboard electrical power supply system for powering both the stretcher itself and a plurality of associated medical devices that can be used to provide potentially life-saving care to the patient during the transportation process. Additionally, there is also a long felt need in the art for an onboard electrical power supply system for a portable patient stretcher that does not require an external power source or tethering to the same via, for example, an extension cord, and that is rechargeable, detachable from the stretcher, and capable of being transported by hand to a remote location. The patient transport system of the present invention satisfies all of the above referenced needs and more.

Throughout this specification the terms “stretcher”, “portable stretcher”, “patient transport system” and “patient transport unit” may be used interchangeably to refer to one or more patient transport assemblies used for medical care inside hospitals or other places. Likewise, the terms “Emergency Medical Services” and “EMS” may be used interchangeably, and the terms “medical appliances”, “medical devices” and “medical equipment” will hold the same meaning throughout the invention.

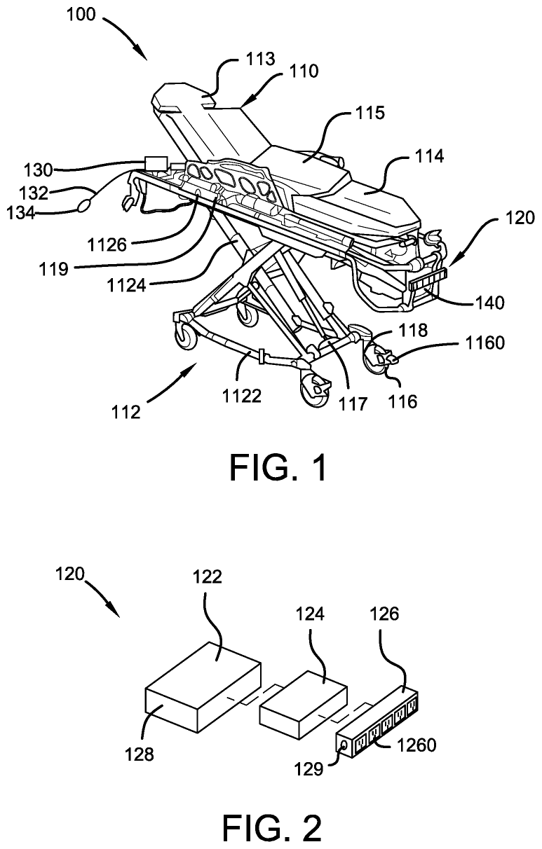

Referring initially to the drawings, FIG. 1 illustrates a perspective view of one potential embodiment of the improved patient transport system 100 of the present invention and in accordance with the disclosed architecture. The improved patient transport system 100 is preferably comprised of a portable stretcher device or assembly 110, an onboard electrical power supply system 120 removably or fixedly attached thereto, and one or more medical devices 130 removably or fixedly attached to the portable stretcher device 110 and/or in electrical communication with the onboard electrical power supply system 120.

The portable stretcher device 110 is similar to those portable stretcher devices known in the art, and is typically comprised of a frame assembly 112, a head support 113, a patient receiving surface 115 attached to the frame assembly 112, a foot portion 114, one or more handles 119 and a plurality of wheels 116 also attached to said frame assembly 112 for easily transporting the portable stretcher device 110 across a hard surface, such as a floor or a parking lot by a user (not shown). More specifically, and as best illustrated in FIG. 1, the frame assembly 112 may be further comprised of various interconnected subframe components including, without limitation, a base frame 1120, a pair of longitudinally spaced-apart elevation or folding frame elements 1124 and an upper frame 1126. Base frame 1120, or a portion thereof, may be optionally covered by a shroud (not shown), or may remain open. Shroud is generally used to accommodate instruments or to conceal the underside of the stretcher device 110. The base frame 1120 can also be designed in such a way that it acts as a carrier or storage area for, by way of example and not limitation, the plurality of medical devices 130, medicine, supplies or the like.

Base frame 1120 also provides support for wheels 116. More specifically, wheels 116 are attached to and extend downwardly from the base frame 1120 to engage the floor or other surface upon which portable stretcher device 110 moves or rests. In a preferred embodiment of the invention, at least one of the wheels 116 includes a brake 1160 for preventing and regulating rotation of the wheels 116 and locking the same, thus precluding further movement of the portable stretcher device 110. In a further preferred embodiment of the invention, a pair of wheels 116 each having a brake 1160 may be provided. For example, each of a forward and a rear wheel assembly 116 may include a brake 1160, such that actuation of the brakes 1160 will lock and prevent movement of both the forward and rear wheels 116 of the portable stretcher device 110.

The elevation/folding elements 1124 of frame 112 may be used to adjust the overall height and positioning of the portable stretcher device 110, along with providing mechanical support thereto. Additionally, and as is known in the art, the portable stretcher device 110 may further comprise a plurality of hand or foot operated pedals or automatic switches (not shown) that may be used to manipulate the elevation/folding elements. More specifically, pedals and/or automatic switches can be used to actuate the elevation mechanisms to rise, lower, and tilt portions of the upper frame 1126 and the various elements supported thereon (e.g., head support 113, foot support 114, patient receiving surface 115, etc.) relative to the floor. For example, upper frame 1126 may provide support for one or more of head support 113, patient receiving surface 115, and foot portion 114. Alternatively, each of head support 113 and foot portion 114 may be repositionably attached to patient receiving surface 115 which, in turn, may be attached to frame 112 via, for example, upper frame 1126.

The advantages of having an onboard electrical power supply system 120 on portable stretcher device 110 are numerous, and include the ability to provide electrical power to a plurality of medical devices 130 in a remote location and without reliance upon traditional external power sources. However, another such advantage is to use onboard electrical power supply system 120 to power the portable stretcher device 110 itself. Accordingly, in a preferred embodiment of the present invention, the portable stretcher device 110 is further comprised of an electrical motor 117 and a drive assembly 118 in electrical communication with the onboard electrical power supply system 120 for powering the wheels 116 of the portable stretcher 110 when brakes 1160 are in a released position, thereby making the improved patient transport system 100 and the patient positioned thereon (not shown) easier to transport for the EMS professional or other first responder (also not shown). It is also contemplated that the drive assembly 118 can also be used to automate adjustment of elevation/folding elements 1124, and other features of the portable stretcher device 110.

As previously stated, the onboard electrical power supply system 120 may be removably attached to the portable stretcher device 110 so that it can be removed and transported by hand to a remote location to provide care to an injured patient where it not be otherwise practical to immediately take the entire portable stretcher device 110. Nonetheless, it is also contemplated that the onboard electrical power supply system 120 may be permanently affixed to, or integrated in, the portable stretcher device 110 to, for example, prevent theft or loss. As best shown in FIGS. 2 through 4, onboard electrical power supply system 120 is preferably comprised of a battery pack 122, a power inverter 124, a power strip 126, a charging port 128, and one or more electrical switches 129, all in electrical communication with one another, either directly or indirectly, and capable of providing stand-alone electrical power to the portable stretcher device 110 and/or a plurality of medical devices 130.

The battery pack 122 is preferably rechargeable and can be recharged via the charging port 128, which in turn can be in electrical communication with a traditional power source such as a wall outlet or a generator (not shown). Battery pack 122 may be comprised of a single battery or multiple batteries, and said batteries 122 are preferably rechargeable batteries such as nickel-cadmium batteries. Nonetheless, it is also contemplated that other types of batteries can also be used including, without limitation, lithium-ion, nickel metal hydride, and the like. Further, an electric cord system (not shown) can be used for connecting an external power (alternating current or direct current) to charge the batteries 122 via charging port 128, as needed. The charging port 128 may further include a charge indicator (not shown) regarding the charge status of the batteries 122. The charge indicator can be selected from one of a LED, liquid crystal display (LCD), an electrophoretic display, or an electronic ink display, though it is contemplated that other mechanical type charge indicators may also be used.

Once charged, the battery pack 122 provides electrical power to the power strip 126 via the inverter 124. The power strip 126 further comprises a plurality of outlets 1260 to which the portable stretcher device motor 117 and/or plurality of medical devices 130 may be plugged into to receive electrical power. It is also contemplated that the power strip 126 could comprise one or more charging ports for other electronic devices (not shown), such as smart phones and the like. In an alternate embodiment, the battery pack 122 can be replaced by, or supplemented with, fuel cells, solar cells or the like, as additional and portable sources of electrical power.

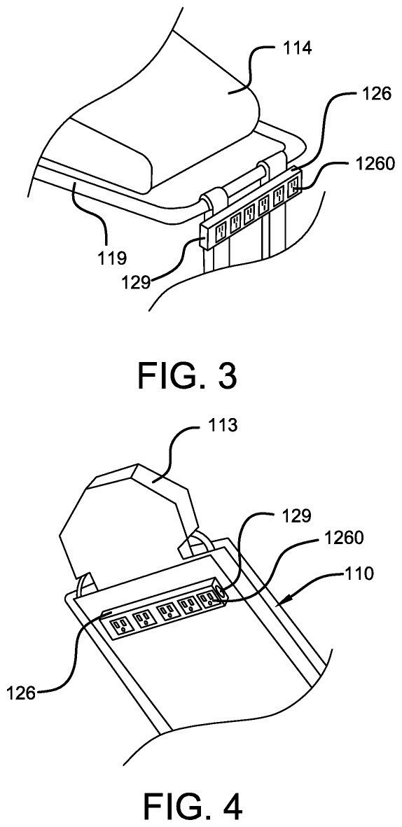

In a preferred embodiment of the present invention, onboard electrical power supply system 120 may be contained within a single housing, wherein only the power strip 126 and the charging port 128 are attached outside of, or outwardly facing from, the housing for easy access by a user. This particular layout allows the batteries 122 to be charged from an external source via charging port 128, and then the electrical power is routed through the power inverter 124 to the outlets 1260 of power strip 126. In an alternative embodiment, the power strip 126 is not attached to or part of the housing. Rather, the power strip 126 may be attached elsewhere along the portable stretcher device 110, but in electrical communication with other components of the onboard electrical power supply system 120, as best shown in the examples provided in FIGS. 3 and 4.

In a further preferred embodiment of the present invention, the onboard electrical power supply system 120 may also be equipped with a battery monitoring algorithm, wherein the voltage, current, and/or temperature of batteries 122 can be detected and measured using a battery monitor (not shown), and displayed on a display provided with the power strip 126. Any suitable display technology may be used for the display including, without limitation, liquid crystal display (LCD), field emission display (FED), plasma, etc. In this manner, the battery monitor may update the EMS professional or other first responder with information about various important battery parameters, such as, but not limited to, the battery's 122 current capacity, remaining capacity, temperature, time left until discharge, any flags or warnings regarding the battery 122, and/or other battery data.

The batteries 122 of the present invention provide the required high energy and power density to bear the load of multiple medical devices 130 at a time. The batteries 122 are also preferably designed with outstanding reliability and safety, and should meet or exceed the requirements for battery size, shape, power, longevity and stability under extreme conditions. The batteries 122 provide the medical devices 130 with the portable power and energy management systems needed in both hospital and emergency-care settings.

The plurality of medical devices 130 may be any medical device commonly known in the art that requires electrical power to function and that is useful in providing immediate care to a patient in a remote setting. Examples of such medical devices 130 include, but are not limited to, ventilator support, suction units, defibrillator units, pulse oximetry sensors, electrocardiogram sensors, oxygen sensors, carbon dioxide sensors, pressure sensors, oscillometer blood pressure sensors, intra-aortic balloon pumps, infusion pumps, physiologic monitoring systems, patient restraint systems, pulse oximeters, and the like.

Each medical device 130 preferably comprises an electrical cord 132 and an associated electrical plug 134 for connecting to a selected one of power outlets 1260 on power strip 126. In this manner, the onboard electrical power supply system 120 may be used to power said medical devices 130 without the need for a wall outlet or other traditional grid based power source, and affords EMS professionals and other first responders with a portable and continuous power source for all of their electronic devices.

In yet another embodiment of the present invention, the patient transport system 100 may further comprise a light or a plurality of lights 140 in electrical communication with, and powered by, the onboard electrical power supply system 120. For example, patients sometimes need to be transported by patient transport system 100 at night and/or through poorly lit environments. Lighting devices 140 can be added to the patient transport system 100 such that both the patient and the path forward can be viewed by the EMS professionals or other first responders. More specifically, the lighting devices 140 may be removably attached to, for example, frame 112 and be repositioned thereabout to suit user need and/or preference. According to an exemplary embodiment, the patient transport system 100 may further comprise additional lighting devices 140, also powered by the onboard electrical power supply system 120, and attached to the base frame 1120 for illuminating the ground surface around patient transport system 100.

FIG. 3 illustrates a partial perspective view of one potential embodiment of the onboard electrical power supply system 120 of the improved patient transport system 100 of the present invention removably attached to the portable stretcher device 110 in accordance with the disclosed architecture, and FIG. 4 illustrates a partial perspective view of an alternative embodiment of the onboard electrical power supply system 120 of the improved patient transport system 100 fixedly attached to the portable stretcher device 110. Notwithstanding, it is contemplated that the onboard electrical power supply system 120 can be attached at any suitable location along the portable stretcher device 110.

Embodiments of the present invention not only provide ease in patient care, but also increased utility through flexible options and features, which are easy to operate and provide convenience to the patient, medical staffs and caregivers. It should be understood by those skilled in the art that while the description contained herein utilizes a stretcher to illustrate embodiments of the present invention, the invention is equally applicable to other patient transport units which can be used for moving a patient from one place to another, such as wheelchairs, cots, pallets, portable beds, operating tables, gurneys and the like.

Notwithstanding the forgoing, the patient transport system 100 of the present invention and its various structural components can be any suitable size, shape, and configuration as is known in the art without affecting the overall concept of the invention, provided that it accomplishes the above stated objectives. One of ordinary skill in the art will appreciate that the shape and size of the patient transport system 100 and its various components, as show in the FIGS. are for illustrative purposes only, and that many other shapes and sizes of the system 100 are well within the scope of the present disclosure. Although the dimensions of the system 100 are important design parameters for good performance, the system 100 and its components may be any shape or size that ensures optimal performance during use and/or that suits need and/or preference of patients, medical staffs and caregivers.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A patient transport system comprising:
a stretcher assembly; and
an onboard electrical power supply system.

2. The patient transport system of claim 1, wherein the onboard electrical power supply system is removably attachable to the stretcher assembly.

3. The patient transport system of claim 1, wherein the onboard electrical power supply system is comprised of an inverter, a battery pack, a power strip, and a charging port.

4. The patient transport system of claim 3, wherein the inverter is in electrical communication with the battery pack and the power strip.

5. The patient transport system of claim 3, wherein the battery pack is rechargeable and is in electrical communication with the charging port.

6. The patient transport system of claim 1 further comprising at least one medical device requiring electrical power to operate.

7. The patient transport system of claim 6, wherein the at least one medical device is powered by the onboard electrical power supply system.

8. The patient transport system of claim 3, wherein the power strip is comprised of a plurality of electrical outlets.

9. The patient transport system of claim 1, wherein the stretcher assembly is comprised of an electrically powered drive assembly.

10. The patient transport system of claim 9, wherein the electrically powered drive assembly receives electrical power from the onboard electrical power supply system.

11. A transport system for transporting a patient and comprising:
a stretcher assembly comprised of an electrically powered drive assembly; and
an onboard electrical power supply system removably attached to the stretcher assembly.

12. The transport system of claim 11, wherein the onboard electrical power supply system is comprised of an inverter, a battery pack, a power strip, and a charging port.

13. The transport system of claim 12, wherein the inverter is in electrical communication with the battery pack and the power strip.

14. The transport system of claim 12, wherein the battery pack is rechargeable and is in electrical communication with the charging port.

15. The transport system of claim 11 further comprising at least one medical device requiring electrical power to operate.

16. The transport system of claim 15, wherein the at least one medical device is powered by the onboard electrical power supply system.

17. The transport system of claim 12, wherein the power strip is comprised of a plurality of electrical outlets.

18. The transport system of claim 11, wherein the electrically powered drive assembly is powered by the onboard electrical power supply system.

19. A patient transport system comprising:
a stretcher assembly comprised of an electrically powered drive assembly having a motor and a plurality of wheels;
at least one medical device attached to the stretcher assembly;
at least one lighting device attached to the stretcher assembly; and
an onboard electrical power supply system comprised of an inverter, a battery pack, a power strip, and a charging port.

20. The patient transport system of claim 19, wherein the at least one medical device and the electrically powered drive assembly are powered by the onboard electrical power supply system.
